(19) United States
(12) Patent Application Publication
(10) Pub. No.: US 2026/0147252 A1
(43) Pub. Date: May 28, 2026

(54) ACOUSTO-OPTIC MODE SWITCHING IN MULTICORE OPTICAL FIBER

(71) Applicant: CORNING INCORPORATED, CORNING, NY (US)

(72) Inventors: Paulo Clovis Dainese, JR., Painted Post, NY (US); Agnivo Gosai, Painted Post, NY (US); Seyyed Ali Hassani Gangaraj, Ithaca, NY (US); Karl William Koch, III, Elmira, NY (US); Tuerhong Maitiniyazi, Horseheads, NY (US); William James Miller, Horseheads, NY (US)

(21) Appl. No.: 19/375,657

(22) Filed: Oct. 31, 2025

Related U.S. Application Data
(60) Provisional application No. 63/725,640, filed on Nov. 27, 2024.

(51) Int. Cl. G02F 1/335

(52) U.S. Cl. CPC G02F 1/335

(57) ABSTRACT

Efficient acousto-optic switching of light between two cores of a multicore optical fiber can be achieved using fiber configurations with cores differing in their effective refractive indices, by simultaneously exciting two flexural acoustic waves of different frequencies to transfer the light in a two-step process from one core to an intermediate cladding mode and then from the intermediate cladding mode to the other core. The intermediate cladding mode may be selected to achieve high, similar coupling rates between the two cores and the cladding modes, and sufficient acoustic frequency separation from neighboring cladding modes.

### CROSS REFERENCE TO RELATED APPLICATION

This application claims the benefit of priority under 35 U.S.C. § 119 of U.S. Provisional Application Ser. No. 63/725,640 filed on Nov. 27, 2024, the content of which is relied upon and incorporated herein by reference in its entirety.

### BACKGROUND

Optical switches are key components in many optical communication networks. In classical optical communication, optical switching can be implemented by opto-mechanical, thermo-optic, and electro-optic switching mechanisms. In quantum-optical communication, where the requirements on loss and switching time are especially stringent, however, these conventional switches are often inadequate. Opto-mechanical and thermo-optic switches enable low insertion loss, but suffer from low switching speed. Electro-optic switches, on the other hand, facilitate fast switching, but at the cost of high insertion loss (e.g., on the order of 3 dB). Acousto-optic switching has emerged as a promising alternative mechanism for achieving low-loss, high-speed fiber-based optical switches suitable for use, in particular, in quantum computing and quantum communication systems. However, acousto-optic switch design entails a complex set of considerations that significantly impact switching efficiency.

### BRIEF DESCRIPTION OF THE DRAWINGS

Described herein are acousto-optic switch devices based on multicore (in particular, e.g., dual-core) optical fiber structures, configured for efficient optical coupling between the two fiber cores.

FIG. 1A is a schematic illustration of a dual-core fiber acousto-optic switch device, in accordance with various embodiments.

FIG. 1B illustrates example multicore fibers with more than two cores that may be used in an acousto-optic switch device in place of a dual-core fiber, in accordance with various embodiments.

FIG. 1C illustrates an acousto-optic switch device with an alternative configuration of the acoustic signal source relative to the optical fiber, in accordance with various embodiments.

FIGS. 1D and 1E illustrate the generation of an acoustic signal with two frequency components, in accordance with various embodiments.

FIG. 2A is a plot of the switching time vs. acoustic frequency for two acousto-optic interaction lengths, as determined by analytical modeling of an example switch device.

FIG. 2B is a plot of the acoustic wavelength vs. the acoustic frequency for two fiber diameters, as determined by analytical modeling of an example switch device.

FIG. 3 is a flow chart illustrating a procedure for numerically modeling a multicore fiber acousto-optic switch device, in accordance with various embodiments.

FIGS. 4A-4C provide a transverse cross section, refractive-index profile through one core, and table of geometric and optical parameters, respectively, of an example dual-core fiber with low-index trenches surrounding the cores.

FIG. 5 illustrates two-step optical coupling between the cores of the dual-core fiber of FIGS. 4A-4C in the presence of an acoustic signal including two frequency components.

FIG. 6 illustrates coupling rates of different cladding modes with the bound modes supported by cores for the dual-core fiber of FIGS. 4A-4C, as determined by numerical modeling.

FIG. 7 illustrates the numerically modeled light transfer dynamics of a switch device including the dual-core fiber of FIGS. 4A-4C, operated to utilize the target intermediate cladding mode identified in FIG. 6, with a plot of the fraction of optical power in the two core modes and the intermediate cladding mode as a function of length along the fiber.

FIGS. 8A-8C provide a transverse cross section, refractive-index profile, and table of geometric and optical parameters, respectively, of an example dual-core fiber without low-index trenches surrounding the cores.

FIG. 9 illustrates two-step optical coupling between the cores of the dual-core fiber of FIGS. 8A-8C in the presence of an acoustic signal including two frequency components.

FIG. 10 illustrates coupling rates of different cladding modes with the bound modes supported by cores for the dual-core fiber of FIGS. 8A-8C, as determined by numerical modeling.

FIG. 11 illustrates the numerically modeled light transfer dynamics of a switch device including the dual-core fiber of FIGS. 4A-4C, operated to utilize the target intermediate cladding mode identified in FIG. 10, with a plot of the fraction of optical power in the two core modes and the intermediate cladding mode as a function of length along the fiber.

FIGS. 12A and 12B illustrate the light transfer dynamics of the switch device including the dual-core fiber of FIGS. 8A-8C that results from the attempt to acousto-optically couple the core modes via an intermediate cladding mode with only one acoustic mode, rather than two modes.

FIGS. 13A-13C provide a transverse cross section, refractive-index profile, and table of geometric and optical parameters, respectively, of an example dual-core fiber in which the two cores differ in both radius and refractive index.

FIG. 14 illustrates coupling rates of different cladding modes with the bound modes supported by cores for the dual-core fiber of FIGS. 13A-13C, as determined by numerical modeling.

FIG. 15 illustrates the numerically modeled light transfer dynamics of a switch device including the dual-core fiber of FIGS. 13A-13C, operated to utilize the target intermediate cladding mode identified in FIG. 14, with a plot of the fraction of optical power in the two core modes and the intermediate cladding mode as a function of length along the fiber.

FIGS. 16A-16D illustrate useful ranges of geometric and optical fiber parameters for switch devices in accordance herewith, with FIGS. 16A and 16B providing a transverse cross section and table of associated parameter ranges, respectively, for a dual-core optical fiber without trenches, and FIGS. 16C and 16D providing a transverse cross section and table of associated parameter ranges, respectively, for a dual-core optical fiber with low-index trenches surrounding the cores.

FIGS. 17A-17C are graphs illustrating, for a switch device with a tapered dual-core optical fiber as a function of tapering coefficient, the effective refractive indices of the core and cladding modes, the acoustic frequencies of the driving flexural waves for inducing coupling between the cladding and each of the cores, and the difference in acoustic frequencies between the two core-cladding pairs, respectively, as determined by numerical modeling.

FIGS. 18A and 18B provide a transverse cross section and refractive-index profile, respectively, of a dual-core optical fiber with a low-index outer cladding.

FIG. 19 is a schematic diagram illustrating two-phonon resonance acousto-optic mode coupling with non-zero phase mismatch coefficients, in accordance with various embodiments.

FIGS. 20A and 20B are graphs of the maximum fraction of optical power in the intermediated cladding mode and the acousto-optic interaction length for maximum conversion, respectively, plotted vs. the momentum deviation percentage, as determined by numerical modeling.

### DESCRIPTION

Disclosed herein are acousto-optic switches that enable switching light selectively between two cores of a 1×2 multi-core, e.g., dual-core, optical fiber. Like in thermo-optic and electro-optic switching approaches, acousto-optic switching is initiated by a change in the refractive index of the optical material triggered by a controlled external stimulus, but instead of temperature as in thermo-optic switches or an electric field or voltage as in electro-optic switches, the stimulus in acousto-optic switches is a flexural (or “bending”) acoustic wave excited via an external acoustic signal source, e.g., an ultrasonic piezoelectric transducer (PZT). In accordance herewith, the two fiber cores are configured, by choice of material and/or dimensions, to have slightly different effective refractive indices n_{eff,c1} and n_{eff,c2}.

The switch of the optical mode from one fiber core (the “host”) to the other (the “destination”) takes place via a two-step acousto-optic mode coupling process. In some embodiments, this process involves optical mode coupling from a the first, host core mode to an intermediate cladding mode, resonantly initiated by an acoustic wave of frequency fₘ₁, followed by optical mode coupling from this intermediate cladding mode to the second, destination core mode, resonantly initiated by a second acoustic wave of frequency fₘ₂. The acoustic waves serve to induce an assymmetric perturbation of the effective refractive indices in the fiber cores that compensates for the momentum mismatch between the two optical modes in each of the two core-cladding mode pairs, which do not couple to each other in the absence of the respective acoustic wave. More specifically, the applied acoustic wave frequencies fₘ₁ and fₘ₂ are chosen such that the difference between their respective acoustic wavelengths Λₘ₁ and Λₘ₂ is equal to the beat length between the optical modes in the first and second cores (resulting from the differing effective refractive indices of the two cores), and that the first and second acoustic wavelengths Λₘ₁ and Λₘ₂ individually are each equal to the beat length between the optical mode of the first or second core, respectively, and the intermediate cladding mode. These conditions are also referred to as phase matching conditions.

The intermediate cladding mode is selected, among a generally large number of cladding modes, based on a number of practical constraints and optimization criteria. To achieve efficient coupling between each of the cores and the cladding, the selected cladding mode preferably has nulls (that is, zero or near-zero optical intensity) at the centers of the first and second cores and is concentrated around boundaries of the first and second cores. The mode is herein deemed “concentrated” around the core boundaries if its intensity at the core-to-cladding boundary is at least fifteen times, and in some embodiments at least twenty times, its intensity at the outer fiber surface. To efficienty transfer light from the first core via the intermediate cladding mode to the second core, rather than coupling back from the cladding into the first core, it is desirable to minimize the difference between the coupling rates associated with the two core-cladding mode pairs. Further, to avoid undesirable cross-coupling between the core modes and a cladding mode other than the selected cladding mode, it is desirable for the selected mode to be separated from any other cladding mode having a high coupling rate to the core modes by a substantial difference between the associated acoustic wave frequencies. In addition, the difference between the acoustic wave frequencies fₘ₁ and fₘ₂ for the selected cladding mode should be small enough for both frequencies to fall within the signal generation band of the acoustic signal source, that is, within the bandwidth (e.g., the 3 dB bandwidth) around the peak acoustic frequency of the PZT or other acoustic signal source (e.g., such that the amplitudes of both acoustic waves are greater than half the peak amplitude of the acoustic signal source), but greater than the frequency resolution of the acoustic signal source.

In some embodiments, the two-step acousto-optic mode coupling process to transfer light from the host core to the destination core via an intermediate cladding mode involves two-phonon resonance mode coupling. In two-phonon resonance mode coupling, the coupling between each of the cores modes and the intermediate cladding mode is off-resonance, resulting in a reduction of the maximum optical power residing in the intermediate cladding mode during the transfer. In this case, the first and second acoustic wavelengths Λₘ₁ and Λₘ₂ individually are no longer equal to the respective beat length between the optical mode of the first or second core and the intermediate cladding mode, but the difference between the acoustic wavelengths Λₘ₁ and Λₘ₂ is still equal to the beat length between the optical modes in the first and second cores. In other words, the acousto-optical coupling between the optical mode of each core and the intermediate cladding mode, each induced by a respective flexural acoustic wave, is off-resonance, whereas the coupling between the two optical cores as induced by the two flexural acoustic waves together, e.g., simultaneously or staggered in time (in a two-phonon process), is on resonance. When transferring light via a two-phonon process, the intermediate cladding mode may be selected based on the same criteria as discussed above with reference to resonant coupling to couple efficiently from one core to the other. However, the optical power in the selected intermediate cladding mode can be reduced by staying off-resonance in the core-to-cladding coupling, which in turn can help reduce optical losses of the switch device.

The described fiber-based acousto-optic switch devices and associated operating methods enable both low optical losses and fast switching. In some embodiments, optical switching losses of 0.1 dB or less and switching times around 1 us or less (and even as low as a nanosecond or a few nanoseconds when driven with acoustic waves at high radio frequency) can be achieved simultaneously. Other benefits of the disclosed devices include easy compatibility with existing optical communication architectures due to their use of optical fiber, as well as compactness resulting from optical switching within a single optical fiber. As a consequence of their high switching performance, the disclosed devices may be suitable for quantum optical switching, and as such serve as key enablers of quantum computation, simulation, and communication architectures. For example, they may facilitate experimentally implementing an all-fiber-loop-based quantum simulation architecture for time-bin encoded Gaussian boson sampling (GBS), e.g., as described in Sempere-Llagostera et al., “Experimentally Finding Dense Subgraphs Using a Time-Bin Encoded Gaussian Boson Sampling Device,” Phys. Rev. X 12 (3), 031045 (2022), incorporated herein by reference, which has heretofore not been implemented for lack of practical quantum hardware devices such as optical switches that meet both low-loss and high-speed requirements.

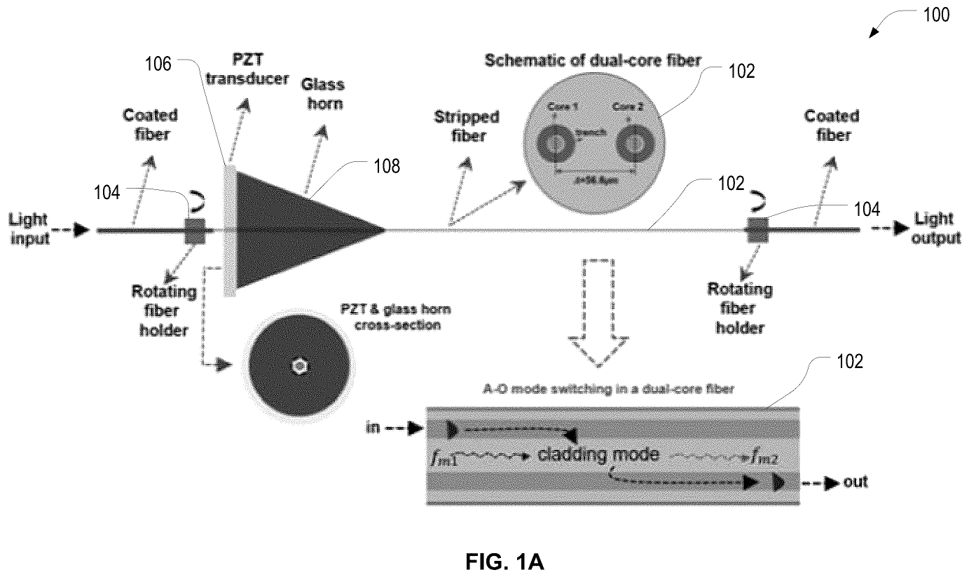

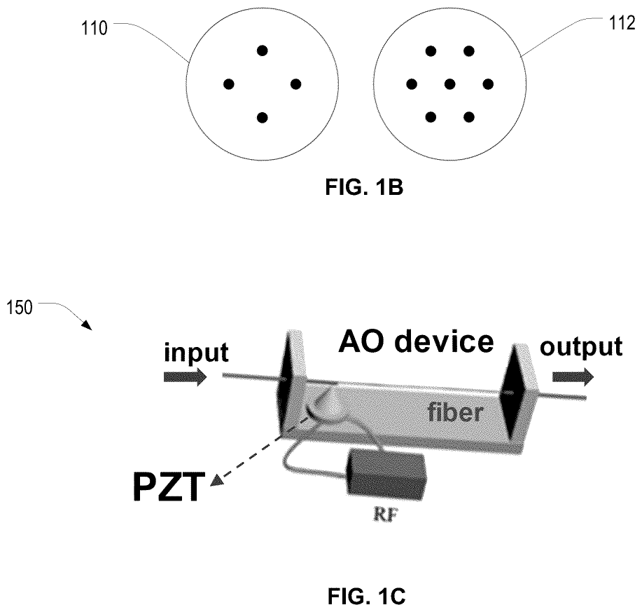

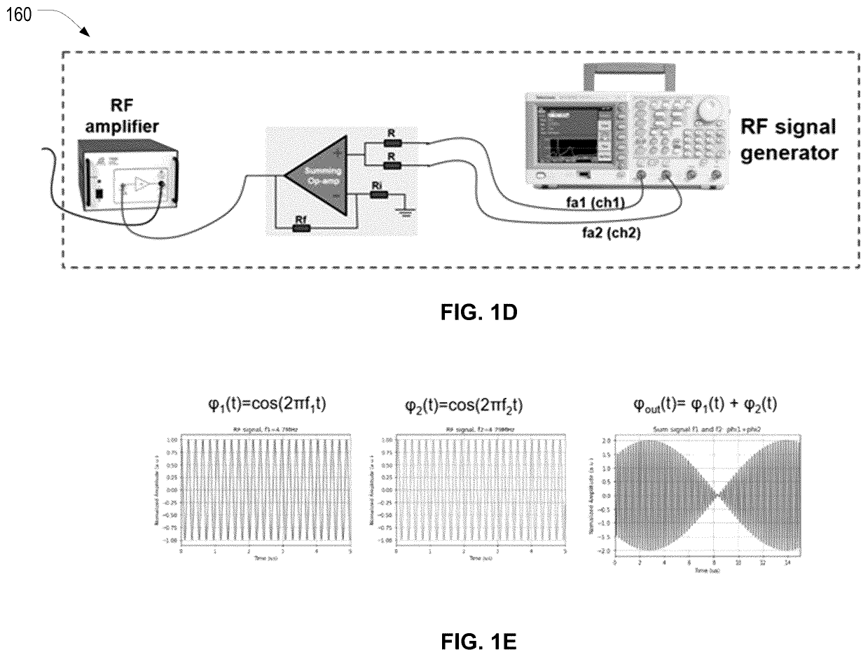

FIG. 1A is a schematic illustration of a dual-core fiber acousto-optic switch device 100, in accordance with various embodiments. The device includes a dual-core optical fiber 102 (also shown enlarged in transverse and longitudinal cross sections) held between two rotating fiber holders 104, and an acoustic signal source (also shown in transverse cross section) implemented, in the illustrated example, by a ring-shaped PZT 106 operating in shear mode and an associated cone-shaped glass horn 108 both arranged co-axially with the optical fiber 102. The optical fiber 102 may be made, e.g., of silica glass or plastic, and achieve a refractive-index contrast between cores and cladding with suitable dopants in the cores, the cladding, or both. For example and without limitation, the cores may be doped with germanium dioxide, phosphorous pentoxide, aluminum trioxide, or titanium oxide to increase their refractive index relative to the cladding, or the cladding may be doped with boron oxide or fluorine to lower its refractive index relative to the cores. Also, combinations of dopants may be used in the cores and/or the cladding to create various desired refractive index profiles. The optical fiber may include a protective surface coating (e.g., of acrylate, fluoropolymer, or some other polymer) as is standard in the industry, but a section of the optical fiber 102 between the rotating fiber holders 104 is stripped of its coating. The stripped fiber section extends at one end through center holes in the PZT 106 and glass horn 108, allowing an acoustic shear wave generated in the PZT ring 106 to be coupled by the glass horn 108 to the fiber 102, where it propagate as a flexural wave. Removing the protective coating from the fiber section enables higher transfer of acoustic energy to the flexural wave.

The optical fiber 102 includes, as shown in the transverse cross-section, two optical cores placed along a common transverse diameter, e.g., equidistantly from the fiber center. The fiber holders 104 allow rotating the fiber to align the two cores with the shear direction of the PZT 106, corresponding to the direction of mechanical displacement associated with the acoustic wave. The two cores differ in their radii, their refractive indices, or both, resulting in slightly different effective refractive indices n_{eff,c1} and n_{eff,c2}. In use, 1×2 multicore fan-out devices (not shown) may be spliced to the optical fiber 102 at both ends of the switch device to enable the selective input of an optical signal into one of the two cores and then branching out the light output from the first, input core and the second, switched core. The optical signal is generally imparted on monochromatic light, e.g., having a wavelength within the visible or infrared regime. For example, in various embodiments, the operating wavelength of the acousto-optic switch is 1550 nm, as is commonly used in fiber-optic communications.

While FIG. 1A depicts a dual-core optical fiber, acousto-optic light switching in accordance herewith can also be applied to two cores of a multicore fiber with more than two cores. For example, as illustrated by the fiber cross sections 110, 112 in FIG. 1B, the fiber may include four cores in a square configuration (with diagonals along the diameter of the fiber) or seven cores in a hexagonal configuration, forming in both cases pairs of cores each arranged along a diameter of the fiber. Light may be switched between a selected pair of cores by aligning the respective diameter with the direction of mechanical displacement associated with the induced acoustic wave. As compared with multicore fibers with more than two cores, dual-core fibers can be beneficial in that they improve the optical isolation between the cores for achieving null coupling in the absence of an acoustic wave. Moreover, fewer cores tend to reduce the cost of fiber fabrication.

FIG. 1C is a schematic illustration of an alternative fiber acousto-optic switch device 150, in accordance with various embodiments. Here, the PZT operates in thickness mode, and the PZT and glass horn are oriented along an axis perpendicular to the optical fiber, with the tip of the glass horn contacting the fiber in the stripped fiber section. A longitudinal acoustic wave generated in the PZT is coupled via the glass horn to the fiber 102, inducing a flexural wave in the fiber. The rotational position of the fiber is adjusted to align the two cores with the direction of the longitudinal wave of the PZT, and thus the direction of mechanical displacement associated with the acoustic wave in the fiber.

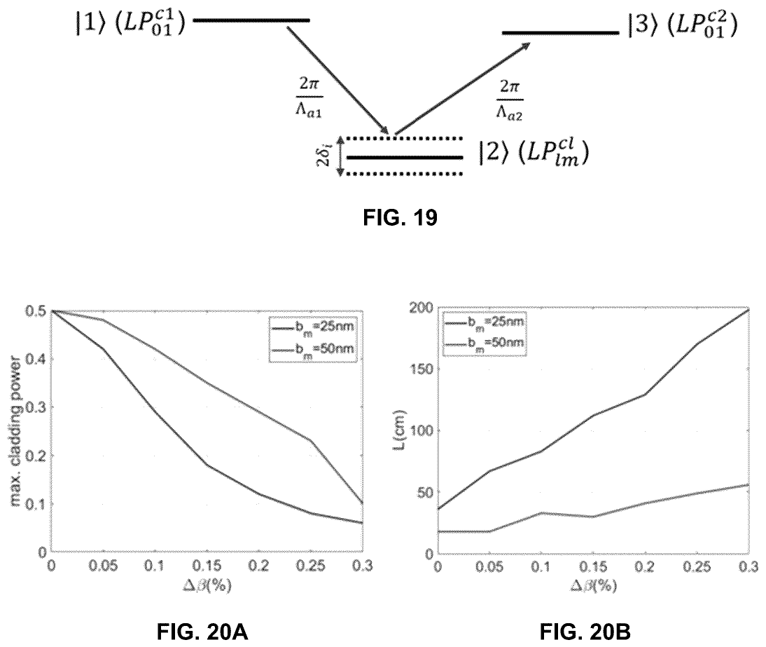

In both switch configurations, the PZT of the acoustic signal source is driven simultaneously at two distinct frequencies, usually in the radio-frequency (RF) range (e.g., between 3 kHz and 300 GHz), to excite flexural acoustic waves at these two frequencies in the fiber. The presence of the two flexural acoustic waves enables a two-step acousto-optic resonant mode switching process. During this switching process, as illustrated in the longitudinal cross section in FIG. 1A, a fundamental mode of the first core is switched to a target cladding mode by the refractive index change induced in the fiber by the flexural acoustic wave at frequency fₘ₁, and then the power in this intermediate target cladding mode is switched to the fundamental mode in the second core due to the refractive index change induced in the fiber by the flexural acoustic wave at frequency fₘ₂. The values of fₘ₁ and fₘ₂ may be selected, within the signal generation band of the acoustic signal source (e.g., within a 150 kHz bandwidth centered at a frequency between 4 MHz and 5 MHz), to meet the acousto-optic resonant phase matching conditions for both steps, explained in more detail below, or the two-phonon resonance phase matching condition explained with reference to FIG. 19.

FIG. 1D illustrates an example RF mixer configuration 160 for generating a drive signal that causes the simultaneous excitation of two acoustic waves at frequencies fₘ₁ and fₘ₂. In this configuration, an RF signal generator 162 generates two AC voltage signals, with frequencies fₘ₁ and fₘ₂, in two respective channels. These voltages are provided as inputs Vᵢₙ₁ and Vᵢₙ₂ to a non-inverting summing operational amplifier 164 with feedback resistor Rf and resistor to ground Ri, which generates output voltage

$${V}_{out} = ( 1 + \frac{{R}_{i}}{f} ) [ ( {V}_{i n 1} + {V}_{i n 2} ) / 2 ] .$$

The output voltage is amplified by an RF amplifier 166 to then serves as the drive signal of the PZT. FIG. 1E illustrates the two signal components at frequencies fₘ₁ and fₘ₂, in the time domain.

In general, acousto-optic resonant mode coupling takes place when the beat length L_{beat} of two optical modes characterized by wave propagation constants, or wavenumbers, β₁ and β₂ (or, equivalently, effective refractive indices n_{eff,1} and n_{eff,2}) is equal to the acoustic wavelength Λₐ of the excited (e.g., flexural) acoustic wave in the optical fiber, i.e., L_{b}=Λₐ, where:

$${L}_{beat} = \frac{2 π}{\vert {β}_{1} - {β}_{2} \vert} = \frac{λ}{\vert {n}_{eff , 1} - {n}_{eff , 2} \vert} \\ {Λ}_{a} = {( \frac{π R {C}_{a}}{{f}_{a}} )}^{1 / 2}$$

Defining the acoustic wavenumber βₐ=2π/Λₐ, acousto-optic resonant mode coupling is conditioned, in other words, on the acoustic wavenumber being equal to the difference between the optical wavenumbers, βₐ=|β₁-β₂| (the phase matching condition). The acoustic wavelength Λₐ for a given acoustic frequency fₐ depends on the radius R of the optical fiber (i.e., the cladding radius) and the acoustic wave velocity Cₐ in silica glass. As will be appreciated by those of ordinary skill in the art, the fiber configuration, including the dimensions and materials of cores and cladding, affects both the effective refractive indices of the cores and cladding as well as the relationship between acoustic wavelength and frequencies, and as such flows into the determination of acoustic frequencies that meet the acousto-optic resonant condition for mode coupling/switching.

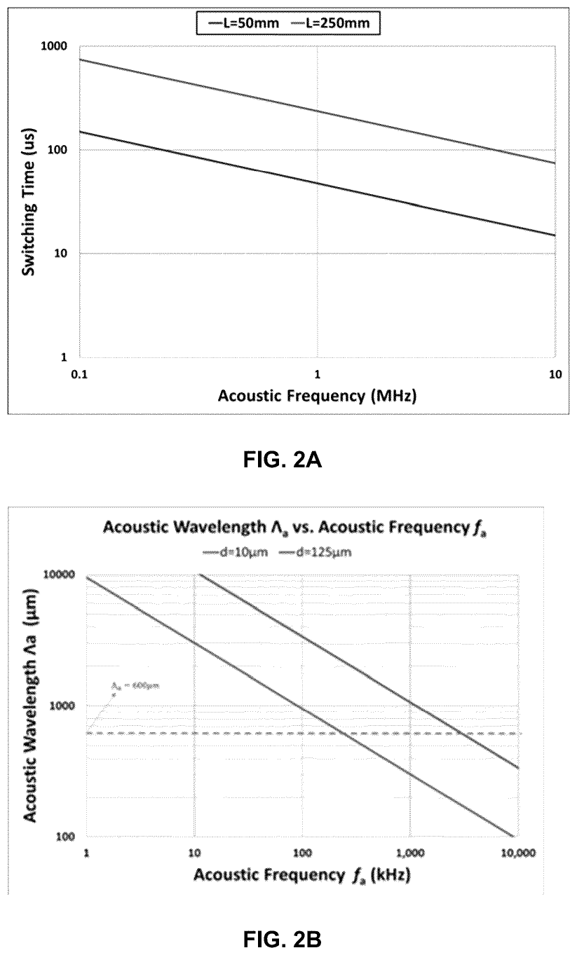

The mode conversion efficiency, or switching efficiency, between the optical modes—that is, the fraction of optical power at a given wavelength λ that is transferred from a source mode to a target mode (e.g., from the fundamental mode of the first core to a selected cladding mode, or from the selected cladding mode to the fundamental mode of the second core)-depends on three major factors: (1) the coupling coefficient between the two modes, which depends on the modal overlap, (2) the amplitude of the generated flexural wave, and, (3) the acousto-optic interaction length. The coupling coefficient and the acousto-optic interaction length are dependent solely on the fiber configuration, whereas the acoustic wave amplitude is dependent on the acoustic signal source (e.g., the capabilities of the PZT and glass horn) as well as the efficiency of bonding between the glass horn and the glass outer cladding of the fiber. The coupling coefficient and acoustic wave amplitude together determine the coupling rate (measured per unit of acousto-optic interaction length, e.g., in l/m). Further, for given optical and acoustic wavelengths, the acousto-optic switching time (that is, transition time between the modes in the acousto-optic interaction region) is dependent on the acousto-optic interaction length (see FIG. 2A). As a result of these interdependencies, the choice of design parameters (such as dimensions and materials of the fiber structure) and operating parameters (such as, in particular, the acoustic frequencies) of the switch device presents various trade-offs between switching efficiency, switching time, and other considerations (such as compactness and availability of suitable acoustic sources).

FIGS. 2A and 2B are graphs illustrating relations, determined with a simple analytical solution to the mode coupling equation, between acoustic frequency, acoustic wavelength, fiber diameter, and switching time of a dual-core acousto-optic switch device in accordance herewith under resonant phase matching conditions. The switching time is modeled as the estimated travel time of the acoustic wave over the acousto-optic interaction length L_{A-I} with an acoustic group velocity ν_{g}:

$$τ = {L}_{A - O} / {υ}_{g} = {L}_{A - O} / \sqrt{π {R}_{cl} {C}_{a} {f}_{a}} ,$$

where, fₐ is the acoustic frequency, R is the radius of the optical fiber, and Cₐ is the acoustic wave velocity in silica glass. (Note that, if two RF frequencies are applied with a time delay, the mode switching can happen prior to the acoustic wave having traveled from one end to the other, that is, the actual mode switching time is shorter than the acoustic wave traveling time along the acousto-optic interaction length.) The modeling of switching time and acoustic wavelength (for which a formula is provided farther above) was performed for values of the acoustic (or extensional) wavelength of Cₐ=5760 m/s and fiber cladding radius of R=62.5 μm.

FIG. 2A plots the switching time vs. acoustic frequency for two acousto-optic interaction lengths, 50 mm and 250 mm, at an optical wavelength of 1550 nm. As can be seen, the switching time can be shorted in two ways: (1) by shortening the acousto-optic interaction length, and/or (2) by increasing the acoustic frequency. For a given cladding mode and associated core-cladding coupling rates, the decrease in mode conversion efficiency associated with shorter interaction lengths can be compensated for by increasing the acoustic wave amplitude if the acoustic signal source permits. In practice, the acoustic wave amplitude is limited by the thickness of the PZT. The thinner the PZT, the smaller are the peak-to-peak displacement and the upper permissible drive voltage (beyond which the PZT is at risk of damage), and the smaller is therefore the acoustic wave amplitude. The thickness of the PZT is inversely proportional to the resonance frequency of the PZT and thus constrained based on the desired operating frequency range. Higher acoustic frequencies entail small PZT thicknesses and, accordingly, smaller acoustic wave amplitudes.

FIG. 2B plots the acoustic wavelength vs. the acoustic frequency for two fiber diameters, 10 μm and 125 μm. As can be seen, increasing the acoustic frequency (e.g., for the purpose of faster switching) decreases the acoustic wavelength. Decreasing the fiber diameter, which may serve to increase the overlap between the acoustic and optical modes as well the acoustic amplitude (due to the decreased fiber volume), and thus the coupling rate, and is sometimes accomplished by tapering the fiber in the interaction region, likewise decreases the acoustic wavelength. A decrease in wavelength entails, in turn, a reduced requisite beat length between the two optical modes to meet the resonant condition for switching; this reduction in beat length can be achieved by increasing the effective index difference between the optical cores.

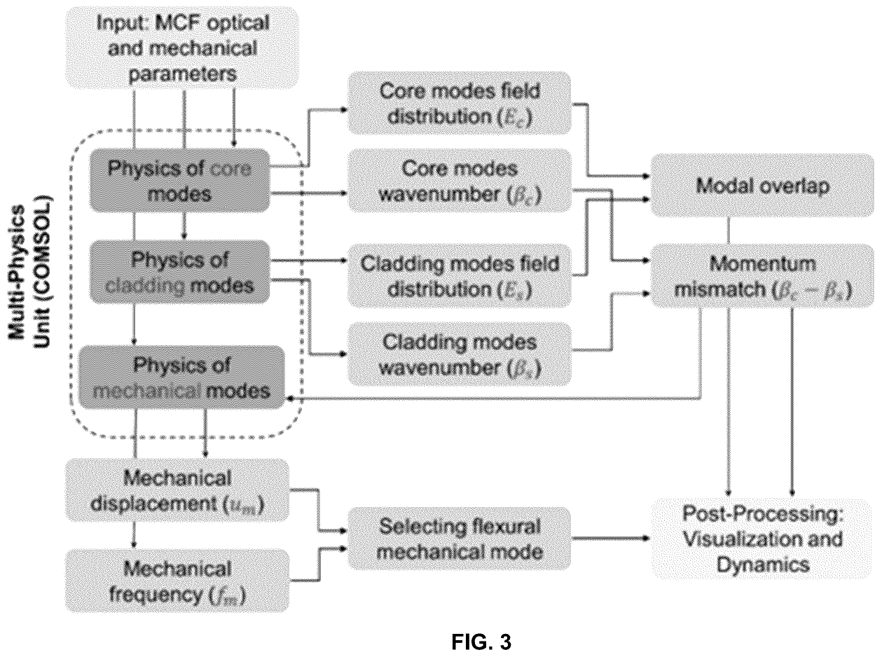

FIG. 3 is a flow chart illustrating a procedure for numerically modeling a multicore (e.g., dual-core) fiber acousto-optic switch device, in accordance with various embodiments. The procedure can generally be implemented by software stored in memory and executed by one or more hardware processors of a general-purpose computer or computer network, by one or more special-purpose hardware processors (e.g., including a digital signal processors (DSP), field-programmable gate array (FPGA), or hardwired electronic circuitry, etc.), or some combination of both. The numerical modeling utilizes a multi-physics modeling unit, including two optical physics units and one mechanical physics unit, that receives the optical and mechanical parameters of the multicore fiber as input. Based on the optical parameters (such as, e.g., dimensions and refractive indices of cores and cladding), the optical physics units compute the wave propagation constants or wavenumbers (that is, real parts of the generally complex-valued wave propagation constants), and electrical (and/or magnetic) field distributions of the core and cladding modes. Subsequently, the field distributions (E_{c} for the core and Eₛ for the cladding) and wavenumbers (β_{c} and βₛ) flow into the calculation of modal overlap and momentum mismatch (difference β_{c}−βₛ between the wavenumbers), respectively, between pairs of a core mode and a cladding mode. Further, based on the mechanical parameters of the multicore fiber (such as, e.g., dimensions, speed of sound, and elastic moduli), the mechanical physics unit computes the distribution of mechanical eigen-modes, characterized by displacement uₘ, and their corresponding eigen-frequencies fₘ, within a frequency range determined based on the momentum mismatch of the core-cladding mode pairs computed by the optical physics units. From among the various mechanical eigen-modes, a flexural mode can then be selected for a given core-cladding mode pair to meet, as closely as possible, the phase matching condition.

Next, the modal overlap and optical wavenumbers of the selected core-cladding mode pair and the selected flexural mode are utilized to determine the dynamics of light transfer. When the fiber is excited by a flexural acoustic wave, the strength of coupling between two optical modes (herein labeled a and b) due to the acoustic vibration is given by the mode coupling rate:

$${κ}_{a , b} = {κ}_{1 , 2} = \vert {b}_{m} \vert \frac{{ω}_{0}}{4} ( \int \int {f}_{P E} dA + \int {f}_{m b} dl ) ,$$

where bₘ is the envelope of the flexural mode (e.g., measured in nm), ω₀=2πf₀ is the optical angular frequency, f_{PE} is the overlap integrand for optical mode coupling due to photoelasticity in the fiber, and f_{mb} is the overlap integrand for optical mode coupling due to the moving-boundary effect in fiber. Acousto-optic mode coupling due to photoelastic and moving-boundary effects is known to those of ordinary skill in the art; more detail can be found, e.g., in Wiederhecker et al., “Brillouin Optomechanics in Nanophotonic Structure,” APL Photon. 4, 071101 (2019), which is incorporated herein by reference in its entirety. The higher the coupling rate, the shorter is the acousto-optic interaction length it takes for a full mode conversion.

Designing the multicore optical fiber for the switch device usually involves an optimization aiming at (1) an acousto-optic interaction length as short as possible, (2) mode coupling rates κ_{1,i} and κ_{i,2} for the coupling between the intermediate cladding mode and the fundamental modes of the first and second cores that are as large as possible for a limited acoustic wave amplitude uₘ, and (3) power losses in the two-step conversion process that are as small as possible.

Using the modeling process of FIG. 3, suitable combinations of multicore (e.g., dual-core) fiber designs (or fiber configurations) and pairs of acoustic frequencies selected to compensate for the momentum mismatch between optical modes of a pair of two cores and a desirable intermediate cladding mode can be identified. An acousto-optic switch device with any given fiber configuration can then be used in conjunction with control and driver circuitry that causes the acoustic signal source to generate acoustic waves at the frequencies associated with the fiber configuration. The control and driver circuitry may include an RF mixer configuration, e.g., as described with reference to FIG. 1C, to create the drive signal from two RF signals of the desired frequencies; these frequencies may be hard-coded or configurable in the RF signal generator, or stored in electronic memory to be read in by the RF signal generator. In some embodiments, the control and driver circuitry is integrated with the multicore fiber and acoustic signal source into a stand-alone switch device. In other embodiments, the switch system includes the fiber-based switch device (including the multicore fiber and acoustic signal source) and the control and driver circuitry as separate devices or sub-systems. In this case, it is possible to store acoustic frequencies determined for multiple fiber configurations in memory, allowing the control and driver circuitry to operate switch devices with any of these fiber configurations via selection of the associated acoustic frequencies. The acoustic frequencies associated with one or more multicore (e.g., dual-core) fiber configurations may be stored, for example, in machine-readable memory such as random access memory (RAM), read-only memory (ROM), CD, DVD, Blu-ray discs, flash memory, etc.

In the following, various example dual-core fiber configurations and associated mode profiles and light transfer dynamics are described.

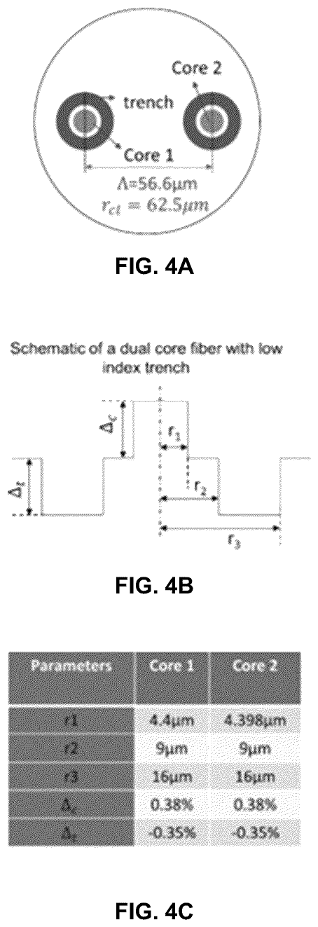

FIGS. 4A-4C provide a transverse cross section, refractive-index profile through one core, and table of geometric and optical parameters, respectively, of an example dual-core fiber with low-index trenches surrounding the cores. In this example, the radius of the fiber is r_{cl}=62.5 μm, the center-to-center distance between the cores is Λ=56.6 μm, and the refractive index of the cladding is n_{cl}=1.4440. The two cores have the same refractive index of 1.4495, corresponding to a 0.38% refractive index delta relative to the cladding, but they differ slightly in the core radius (parameter r₁), which is 4.400 μm for one core and 4.398 μm for the other core. Each core is surrounded by a ring-shaped low-index trench of refractive index 1.4389 (corresponding to a −0.35% refractive index delta relative to the core), extending from radius r₂=9 μm to radius r₃=16 μm (measured from the center of the respective core). As a result of their different radii, the two cores also differ slightly in effective refractive index (parameter n₁) of their bound modes (corresponding to the presence of light in the respective core), between 1.44669 for the larger core and 1.44668 for the smaller core. This difference in effective refractive indices results provides for a core-to-core isolation of approximately −80 dB for a fiber length of around 30 cm.

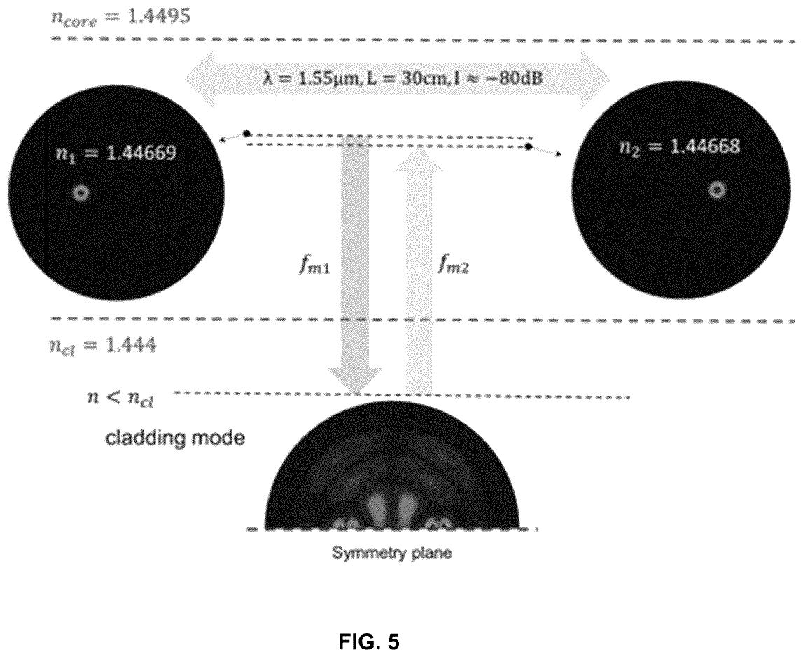

FIG. 5 illustrates two-step optical coupling between the cores of the dual-core fiber of FIGS. 4A-4C in the presence of an acoustic signal including two frequency components. The dashed lines indicate the refractive indices of the cores and cladding, the effective refractive indices of the two core modes (in between the refractive indices of cores and cladding), and the effective refractive index of a selected cladding mode (below the material reflective index of the cladding). Due to the proximity of the effective indices of the cores, achieving direct core-to-core transfer would require an acoustic wavelength significantly larger (e.g., on the order of a decimeter at a wavelength of 1.55 μm) than the acoustic wavelengths in the desired acoustic frequency range (e.g., sub-millimeter wavelengths for acoustic frequencies in the few-MHz range). Furthermore, it is desirable for the dual-core fiber to act as a null-coupler with no coupling between the cores in the absence of an acoustic signal. To address these challenges, an intermediate cladding mode is leveraged for two-step coupling in accordance herewith. With an appropriate cladding mode, it is possible to couple the light from the first core (in this example the larger core) to the intermediate cladding mode using an acoustic mode with frequency fₘ₁, and then coupling the light from the intermediate cladding mode to the second core with a different acoustic mode with frequency fₘ₂, with fₘ₁ and fₘ₂ both falling within the desired acoustic frequency range. The two acoustic modes may be excited in the fiber simultaneously, or staggered but overlapping in time. In various embodiments, the desired frequency range is simply the available frequency range of the utilized acoustic signal source. Acoustic signal sources are readily available with bandwidths between 100 and 200 kHz around center frequencies in the range from tens of kHz to at least 10 MHz. Various example switch devices discussed below assume a source with an available acoustic frequency range from 4 MHz to 5 Hz. FIG. 5 illustrates, in transverse fiber cross sections, the field distributions of the core modes (on the left for the first core and on the right for the second core) and the cladding mode (on the bottom).

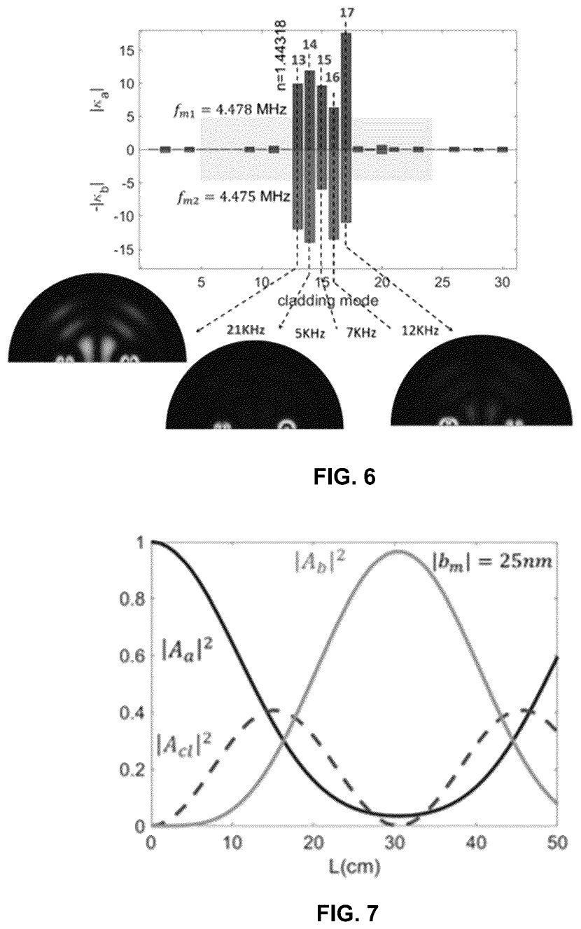

FIG. 6 illustrates coupling rates of different cladding modes with the bound modes supported by cores for the dual-core fiber of FIGS. 4A-4C, as determined by numerical modeling. The upper half of the plot shows the coupling rates |κₐ| of thirty claddings modes with the first, larger core, and the lower half shows the coupling rates −|κ_{b}| between the same cladding modes and the second, smaller core. The thirty cladding modes have been selected around an effective refractive index of n=1.4432. The shaded region indicates those cladding modes (modes #5 through #24) for which the momentum mismatch with the two core modes can be compensated by an acoustic signal wave with a frequency in the range from 4 MHz to 5 MHz. Within this region, as can be seen, cladding modes #13, #14, #15, #16, and #17 have the largest coupling rates. For a desirable cladding mode, beyond just being large, the coupling rates |κₐ| and |κ_{b}| are also close to each other in magnitude. Otherwise, with a substantial difference between the two coupling rates, the rate of light transfer from one core to the cladding mode is either slower or faster than the transfer rate from the cladding to other core, and consequently, the cladding mode or one of the core modes will remain partially populated, reducing the overall transfer efficiency between the two cores. In the example shown, among the cladding modes with high coupling rates, modes #13 has coupling rates |κₐ| and |κ_{b}| that are similar in magnitude.

A comparison of the electric field distributions of various intermediate cladding modes along with their coupling rates allows discerning qualitative characteristics of desirable modes. As can be seen in the field distributions of modes #13, #14, and #17, high coupling rates occur for field distributions that are well-confined around the core boundaries and have nulls at the centers of the optical cores. This concentration of the cladding mode around the core boundary entails high overlap between core and cladding modes, which significantly enhances the contribution of the moving-boundary effect (represented by the term ∫f_{mb} dl in the equation for κ_{a,b}) to the coupling from core to cladding when an acoustic mode is launched into the fiber and causes the core boundary to vibrate. Further, as can be seen from a comparison of the field distributions of cladding modes 13 and 17, similar coupling rates |κₐ| and |κ_{b}| correlate with similar field distributions surrounding the cores. Cladding mode #17 shows a non-negligible discrepancy in the field intensity distribution around the two cores, indicating a larger difference between the magnitude of |κₐ| and |κ_{b}|. By contrast, cladding mode #13 shows more similar field confinement around the two cores, and the magnitudes of |κₐ| and |κ_{b}| are much closer. Additionally, cladding mode #13 is more effectively protected against coupling from the cores into adjacent cladding modes: on the left, there is no cladding mode with large enough coupling rate, and from the right, cladding #13 is well-shielded against cladding mode #14 by a difference in the associated acoustic eigen-frequencies of 21 kHz. By comparison, the eigenfrequency differences between cladding modes #14 to #17 are 5 kHz, 7 kHz, and 12 kHz, and thus these modes are not mutually guarded to the same extent. Based on this combination of criteria, cladding mode #13 stands out as the most desirable intermediate cladding mode in this example, and is accordingly selected as the target intermediate cladding mode. The effective index of cladding mode #13 is n=1.44318, and the acoustic frequencies of the flexural waves used to couple light from the larger core to cladding mode #13 and then to the smaller core are fₘ₁=4.478 MHz and fₘ₂=4.475 MHz, respectively, which fall within the desired acoustic frequency range.

FIG. 7 illustrates the numerically modeled light transfer dynamics of a switch device including the dual-core fiber of FIGS. 4A-4C, operated to utilize the target intermediate cladding mode identified in FIG. 6, with a plot of the fraction of optical power in the two core modes (|Aₐ|² and |A_{b}|²) and the intermediate cladding mode (|A_{cl}|²) as a function of length along the fiber, assuming an acoustic envelope of bₘ=25 nm. As can be seen, light is maximally transferred from the first core via the intermediate cladding mode to the second core over a length of 30 cm. (The small fraction of optical power left in the first core is due to a small difference between the coupling rates |κₐ| and |κ_{b}|. If |κₐ| and |κ_{b}| were exactly equal, 100% of the power would transfer to the second core, and the maximum power fraction in the intermediate mode would be 0.5.)

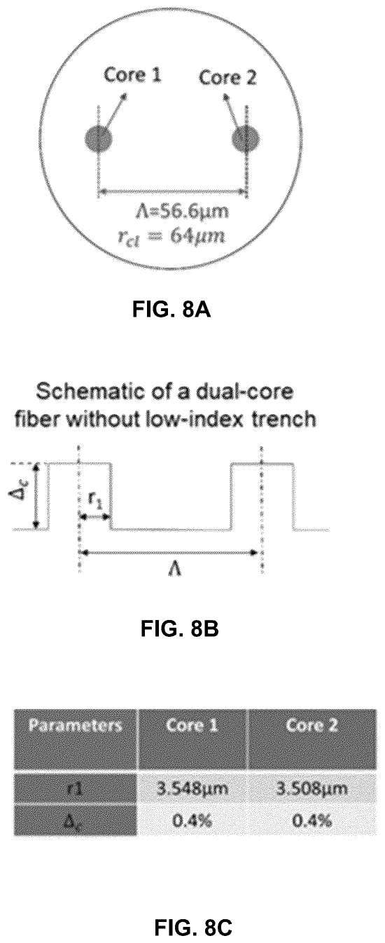

FIGS. 8A-8C provide a transverse cross section, refractive-index profile, and table of geometric and optical parameters, respectively, of an example dual-core fiber without low-index trenches surrounding the cores. In this example, the radius of the fiber is r_{cl}=64 μm, the center-to-center distance between the cores is Λ=56.6 μm, and the refractive index of the cladding is n_{cl}=1.4440. The two cores have the same refractive index of 1.4498, corresponding to a 0.40% refractive index delta relative to the cladding, but they differ in the core radius (parameter r₁), which is 3.548 μm for one core and 3.508 μm for the other core, resulting in effective refractive indices of 1.44614 and 1.44610, respectively. The achievable core-to-core isolation for a fiber length of around 30 cm is about −78 dB, which is smaller than the separation for the dual-core fiber with trenches shown in FIGS. 4A-4C, but generally adequate for practical purposes.

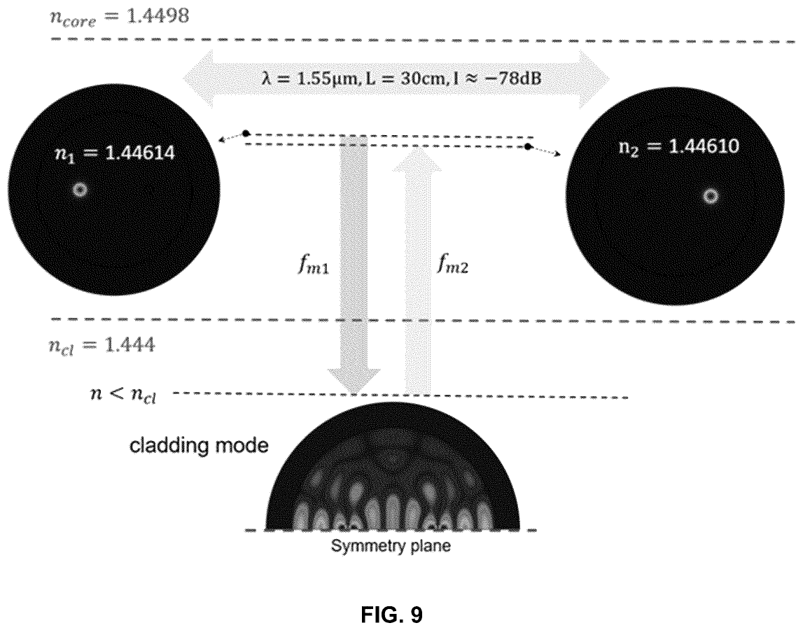

FIG. 9 illustrates two-step optical coupling between the cores of the dual-core fiber of FIGS. 8A-8C in the presence of an acoustic signal including two frequency components. As in FIG. 5, the dashed lines indicate the refractive indices of cores and cladding, as well as the effective refractive indices of the core and cladding modes. The goal is once again to transfer light from one core to the other via an intermediate cladding mode in the presence of acoustic flexural waves with frequencies fₘ₁ and fₘ₂ within the range of 4 MHz to 5 MHz.

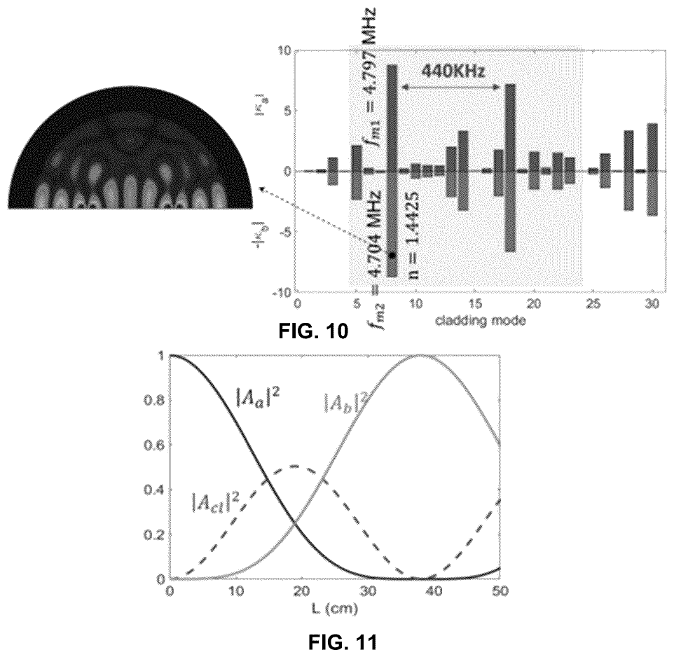

FIG. 10 illustrates coupling rates of different cladding modes with the bound modes supported by cores for the dual-core fiber of FIGS. 8A-8C, as determined by numerical modeling. As in FIG. 6, the upper half of the plot shows the coupling rates |κₐ| of thirty claddings modes with the first, larger core, and the lower half shows the coupling rates −|κ_{b}| between the same cladding modes and the second, smaller core. The thirty cladding modes have been selected around an effective refractive index of n=1.4426. The shaded region indicates those cladding modes (modes #5 through #24) for which the momentum mismatch with the two core modes can be compensated by an acoustic signal wave with a frequency in the range from 4 MHz to 5 MHz. As can be seen, cladding mode #8 has the largest coupling rates and it is well-guarded against the next cladding mode with large coupling rate by an acoustic-frequency difference of 440 kHz.

The field distribution of cladding mode #8 is also shown. Comparing cladding mode #8 in this case with the target cladding mode of the dual-core fiber with trenches, mode #13 in FIG. 6, two important observations can be made: First, similar to cladding mode #13 in FIG. 6, the field distribution of cladding mode #8 in FIG. 10 is exhibits its highest intensity around the core boundary. This observation-consistently with the findings for FIG. 6—suggests that substantial coupling can be achieved if the cladding mode is concentrated near the core boundaries such that, when a flexural acoustic wave is launched, the moving-boundary effect at the core-cladding interface significantly contributes to the coupling between cores and cladding. On the other hand, the comparison also reveals a discrepancy between cladding mode #8 in FIG. 10 and cladding mode #13 in FIG. 6. While cladding mode #13 in FIG. 6 drops off significantly in intensity toward the outer boundary of the fiber, the target cladding mode #8 in FIG. 10 extends to the outer boundary of the fiber at relatively high intensity. (Note that FIGS. 6 and 10 utilize similar color scales.) This difference is rooted in the presence of the low-index trenches around the cores in FIG. 6, which largely prevent the confined field around the core boundary from extending farther into the cladding toward the outer boundary of the fiber. With substantial field intensity reaching the outer surface of the fiber, any unwanted deformation in the fiber surface will tend to cause optical losses, and thus reduce the mode conversion efficiency. Trenches surrounding the cores effectively protect the efficiency of light transfer, even in the presence of any such unwanted deformation on the fiber surface.

The target cladding mode, #8, in FIG. 10 has an effective refractive index n=1.4425. The acoustic frequencies of the flexural waves used to couple light from the larger core via cladding mode #8 to the smaller core are fₘ₁=4.797 MHz and fₘ₂=4.704 MHz, respectively, which fall within the desired acoustic frequency range.

FIG. 11 illustrates the numerically modeled light transfer dynamics of a switch device including the dual-core fiber of FIGS. 4A-4C, operated to utilize the target intermediate cladding mode identified in FIG. 10, with a plot of the fraction of optical power in the two core modes and the intermediate cladding mode as a function of length along the fiber. As can be seen, light is fully transferred from the first core via the intermediate cladding mode to the second core over a length of 40 cm, which is longer than the interaction length in FIG. 7, due to the somewhat lower coupling rates in this fiber without trenches.

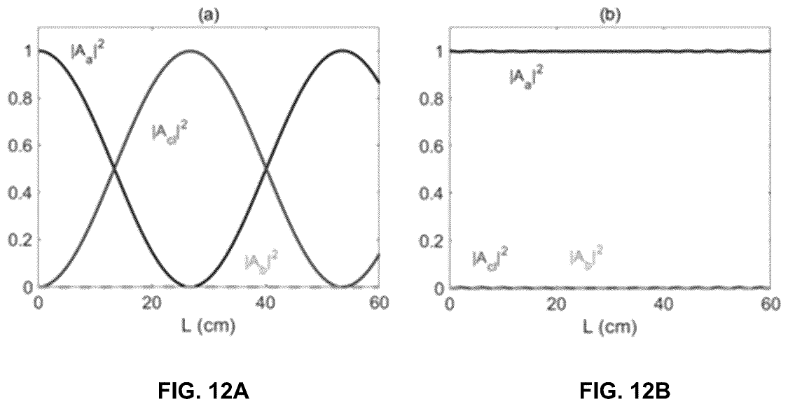

FIGS. 12A and 12B illustrate the light transfer dynamics of the switch device including the dual-core fiber of FIGS. 8A-8C that results from the attempt to acousto-optically couple the core modes via an intermediate cladding mode with only one acoustic mode, rather than two modes. Given how close the effective indices of the two bound cores modes of the fiber are, it may seem feasible to transfer light from one core to the cladding and then to the other core with a single acoustic mode. To test this possibility, a scenario in which light is launched into the larger core (on the left in FIG. 8A) and a single acoustic wave having a frequency of fₘ₁=4.797 MHz is launched along the fiber is numerically modeled. The resulting light transfer dynamics is depicted in FIG. 12A. As can be seen, the acoustic mode compensates the momentum mismatch between the larger core and the targeted intermediate cladding mode (in this case, mode #8); however, it does not bridge the light from the cladding mode to the other, smaller core (on the right in FIG. 8A). Next, a scenario is modeled in which the light is again launched into the larger core, but this time an acoustic mode with frequency fₘ₂=4.704 MHz is launched along the fiber. In this case, the acoustic mode can compensate the momentum mismatch between the cladding mode and the smaller core on the right. However, as can be seen in FIG. 12B, which illustrates the light transfer dynamics for this scenario, the light stays in the larger core on the left, and does not couple to the cladding mode. These modeling results suggests that in the proposed dual-core fiber, the two light transfer processes (left core to cladding, and then cladding to right core) are decoupled from each other. This result is also confirmed by the computed coupling rates and momentum mismatch. For instance, the estimated coupling rate and momentum mismatch between the core modes and the target cladding mode are κ≈0.12 rad/cm and

$$Δ β = \frac{δ {n}_{eff} 2 π}{λ} \approx 1.6 rad / cm ,$$

Therefore, when only one acoustic mode exists and completes one of the processes, the other process is very inefficient because

$$\frac{{\vert κ \vert}^{2}}{Δ {β}^{2} + {\vert κ \vert}^{2}} \approx 0.05 .$$

This small ratio shows that the two processes are decoupled from each other. Accordingly, switching light from one core to another relies on the simultaneous excitation of both acoustic modes.

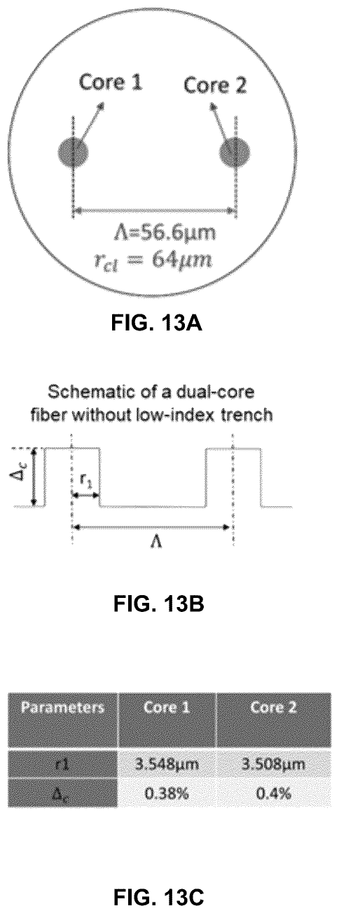

FIGS. 13A-13C provide a transverse cross section, refractive-index profile, and table of geometric and optical parameters, respectively, of an example dual-core fiber in which the two cores differ in both radius and refractive index. Like in the example of FIGS. 8A-8B, the radius of the fiber is r_{cl}=64 μm, the center-to-center distance between the cores is Λ=56.6 μm, the refractive index of the cladding is n_{cl}=1.4440, and the core radii are 3.548 μm and 3.508 μm. The refractive index of the larger core is 1.4495 (corresponding to a 0.38% refractive index delta relative to the cladding), and the refractive index of the smaller core is 1.4498 (corresponding to a 0.40% refractive index delta).

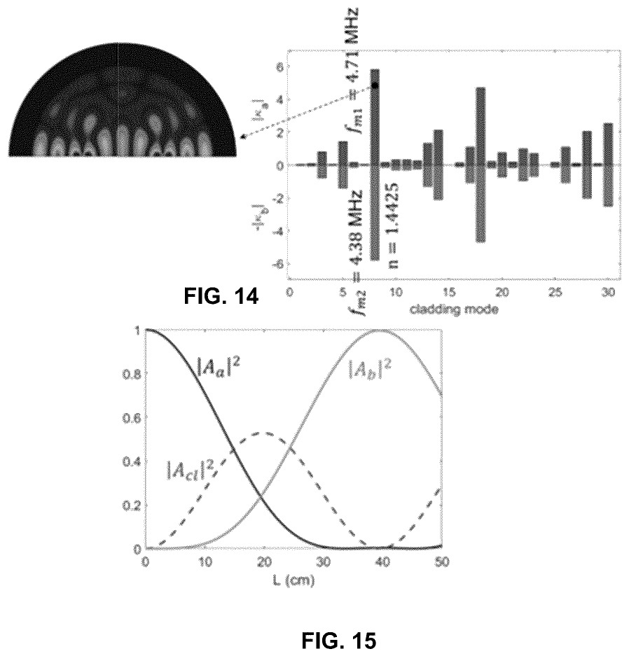

FIG. 14 illustrates coupling rates of different cladding modes with the bound modes supported by cores for the dual-core fiber of FIGS. 13A-13C, as determined by numerical modeling. The upper half of the plot shows |κₐ|, the coupling rate of cladding modes with the core with larger size and smaller optical index, and the lower half shows −|κ_{b}|, the coupling rate between the cladding mode and the other core. The thirty cladding modes have been selected around an effective refractive index of n=1.44261. Cladding mode #8, which is selected as the target cladding mode because of its high and close-to-equal coupling rates between the cladding mode and the two cores, has an effective index around n=1.44250. The acoustic frequencies of the flexural waves to couple the light from the larger core to a cladding mode and then from the cladding mode to the smaller core are fₘ₁=4.71 MHz a fₘ₂=4.38 MHz, respectively, which fall within the desired acoustic frequency band of 4 MHz to 5 MHz. The inset shows the desired target cladding mode, illustrating strong confinement of the field around the core-cladding boundary, which provides for strong coupling from core to cladding and vice versa.

FIG. 15 illustrates the numerically modeled light transfer dynamics of a switch device including the dual-core fiber of FIGS. 13A-13C, operated to utilize the target intermediate cladding mode identified in FIG. 14, with a plot of the fraction of optical power in the two core modes and the intermediate cladding mode as a function of length along the fiber.

As will be appreciated by those of ordinary skill in the art, the specific dual-core fiber structures described above are merely examples, and in general, the discussed principles of fiber design and selection of intermediate cladding and acoustic modes can be applied to a wide range of values of the fiber parameters (which include the number of cores, cladding and core diameters, index delta, etc.).

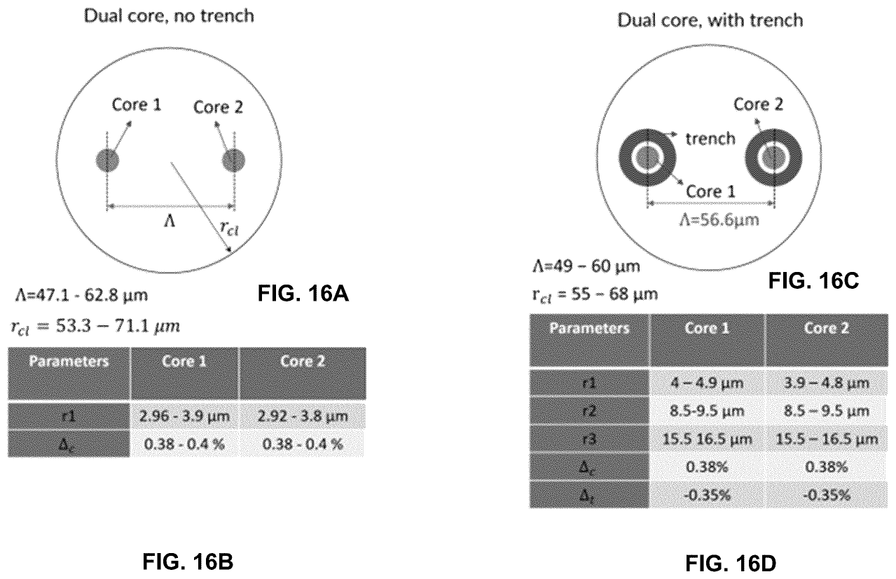

FIGS. 16A-16D illustrate useful (but non-limiting) value ranges of geometric and optical fiber parameters for switch devices in accordance with various embodiments, with FIGS. 16A and 16B providing a transverse cross section and table of associated parameter ranges, respectively, for a dual-core optical fiber without trenches, and FIGS. 16C and 16D providing a transverse cross section and table of associated parameter ranges, respectively, for a dual-core optical fiber with low-index trenches surrounding the cores. These parameter ranges were determined for an optical wavelength of 1550 nm, and are expected to provide good performance at least over a range from 1500-1600 nm. For significantly shorter or longer wavelengths, suitable fiber design parameters for high-performance optical switching can be determined using the numerical modeling process described with reference to FIG. 3.

In some embodiments, the dual-core fiber is tapered down, e.g., to a tapering coefficient or tapering ratio (i.e., ratio of largest to smallest diameter of the tapered fiber) of ˜1.25. Tapering the fiber can improve overlap of the acoustic wave in the fiber with the optical input signal, which reduces, for a given acousto-optic interaction length, the requisite acoustic wave amplitude (corresponding to the vibration displacement) to achieve full mode conversion. As will be apparent to those of ordinary skill in the art, tapering the fiber changes the optical modes, and thus requires adjustments to the acoustic frequencies employed in switching.

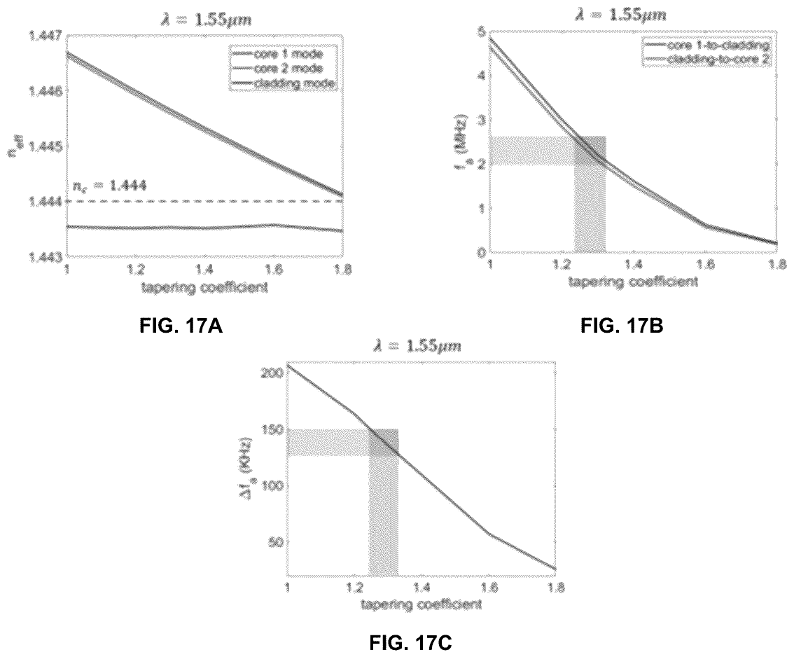

FIGS. 17A-17C are graphs illustrating, as a function of tapering coefficient, the effective refractive indices of the core and cladding modes, the acoustic frequencies of the driving flexural waves for inducing coupling between the cladding and each of the cores, and the difference in acoustic frequencies between the two core-cladding pairs, respectively, as determined by numerical modeling. As can be seen, tapering down the fiber reduces the effective refractive indices of the core modes (without much affecting that of the cladding mode), and the acoustic frequencies of the two driving flexural waves as well as their difference. Accordingly, the acoustic frequencies can be varied simply by tapering down the fiber (which causes cores and cladding to scale together), without the need for a new fiber design. Additionally, the smaller cladding diameter resulting from tapering increases the coupling rate and thus allows achieving full mode switching with smaller acoustic signal amplitudes.

In various embodiments, the above-described optical fiber configurations (with or without trenches surrounding the cores) may be modified by adding, around the cladding surrounding the cores, a lower-index outer cladding. Such a cladding can mitigate perturbations of cladding modes at the fiber surface (e.g., due to dust on the stripped fiber section, surface imperfections, etc.) and improve the stability of the cladding modes and, thus, of acousto-optic mode coupling.

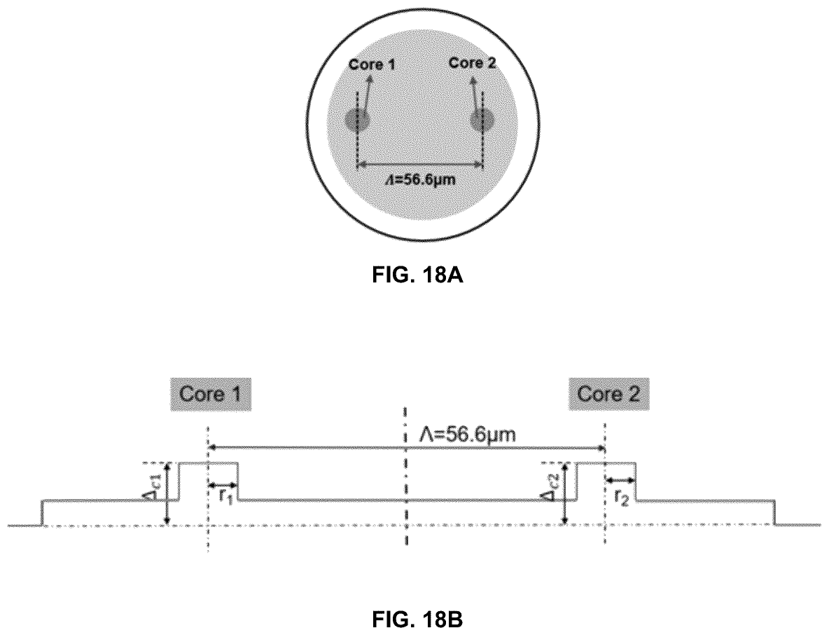

FIGS. 18A and 18B provide a transverse cross section and refractive-index profile, respectively, of a dual-core optical fiber with a low-index outer cladding. The center-to-center distance between the cores and the radii of the cores and the fiber at large may be consistent with the previous examples. However, the refractive index of the cladding, rather than being uniform across the fiber, is stepped, as can be seen in the refractive-index profile in FIG. 18B, to form a relatively higher-index inner cladding (circular in the transverse cross section) in which the cores are embedded, and a lower-index outer cladding (ring-shaped in the transverse cross section) surrounding the inner cladding. The radius of the inner cladding may be between 70% and 95% of the radius of the fiber or outer cladding. The inner cladding may have a refractive index of, e.g., n_{cl1}=1.4440, and the cores may have refractive indices that are, e.g., 0.38%-0.40% higher (consistently with the cladding and core refractive indices in the preceding examples). The outer cladding may have a refractive index that is about 0.15 to −0.30% lower than that of the inner cladding. For example, the cores may have a refractive index of 1.4498, and the inner cladding may have a refractive index of 1.4410.

In the embodiments described so far, acousto-optically induced optical mode switching is enabled by a resonant phase matching process, where the power in the optical mode of the first core is transferred to a target intermediate cladding mode before the power is then transferred to the optical mode of the second core, and where the momentum mismatch between the core and cladding modes in each step, β_{ci}-β_{cl}, is equal to the corresponding acoustic wavenumber βₘᵢ, with i=1 for the first core and i=2 for the second core. The phase mismatch coefficient for each transition, defined as δᵢ=β_{ci}−β_{cl}−βₘᵢ, is zero in this case. (The phase mismatch coefficient is deemed zero when it is within the linewidth of the acoustic wave.) However, mode switching can also be achieved, alternatively, if the phase mismatch coefficient is non-zero, using what is herein called “two-phonon resonance mode coupling.” To enable no-resonantly coupling to a selected cladding mode, the phase mismatch coefficient with respect to the selected mode is generally kept small enough to provide for sufficient acoustic separation from neighboring cladding modes.

FIG. 19 is a schematic diagram illustrating two-phonon resonance acousto-optic mode coupling with non-zero phase mismatch coefficients, in accordance with various embodiments. The levels associated with states |1> and |3>, represented by solid horizontal lines, correspond to the optical wavenumbers of the fundamental modes

$$L {P}_{01}^{c 1} and {LP}_{01}^{c 2}$$

of the first and second cores, and the level associated with state |2>, also represented by a solid horizontal line, corresponds to the optical wavenumber of the target transverse mode

$$( L {P}_{l m}^{cl} )$$

of the cladding that serves as the intermediate cladding mode. Under resonant coupling conditions, the wavenumbers of the two acoustic waves, βₘ₁=2π/Λₐ₁ and βₘ₂=2π/Λₐ₂, are equal to the momentum mismatch between the core and cladding wavenumbers of the respective transition, represented by the vertical separation between the horizontal levels. For off-resonance coupling, when the phase mismatch coefficient is non-zero for both transitions (δ_{1,2}≠0), the acoustic waves cause transitions between state |1> or |3> and an off-resonant state at a level above or below the level associated with state |2>, as indicated by the dashed horizontal lines. Off-resonance coupling occurs when the phase mismatch coefficient is on the order of or greater than the linewidth of the acoustic wave. The phase mismatch coefficients δᵢ (i=1,2), which capture the detuning of the acoustic wavenumbers βₘᵢ from the respective momentum mismatch β_{ci}-β_{cl} between the optical modes of cores and cladding, are equal to each other, such that the difference between the two acoustic wavenumbers matches the momentum mismatch between the optical modes of the two cores, βₘ₁−βₘ₂=β_{c1}−β_{c2}, which renders the two-phonon process “on resonance.”

FIGS. 20A and 20B are graphs of the maximum fraction of optical power in the intermediated cladding mode and the acousto-optic interaction length for maximum conversion, respectively, plotted vs. the momentum deviation percentage, defined as Δβ_{1/2}=δ_{1/2}/(β_{1/2}−β_{cl}) (i.e., the phase mismatch coefficient normalized by the momentum mismatch between core and cladding modes), as determined by numerical modeling. As shown in FIG. 20A, the maximum fraction of power in the cladding mode

$${LP}_{l m}^{cl} , {\vert {A}_{c l} \vert}^{2} ,$$

can be lowered from 0.5 to 0.1 by increasing the momentum deviation percentage up to 0.3% through the above-described off-resonance (or two-phonon resonance) process. Beneficially, a reduction in the energy transferred into the intermediate cladding mode can limit the loss of the device, especially when the cladding mode extends to the surface of the fiber, where it is susceptible to perturbations (such as dust and surface imperfections or flaws). However, off-resonance coupling comes at the cost of increased acousto-optic interaction length (for a given acoustic signal amplitude), as can be seen in FIG. 20B. Complete mode conversion over the same interaction length as in the on-resonance case can be achieved using stronger acoustic signals, corresponding to a larger acoustic deflection.

In one aspect, the present disclosure is directed to an acousto-optic switch device that includes a multicore (e.g., dual-core) optical fiber with first and second optical cores surrounded by a cladding, an acoustic signal source configured to induce a flexural acoustic wave in the multicore optical fiber; and control and driver circuitry configured to operate the acoustic signal source. The multicore optical fiber is configured such that the first optical core guides a first core mode having a first optical wavenumber, the second optical core guides a second core mode having a second optical wavenumber that differs from the first optical wavenumber, and the cladding can guide multiple cladding modes having multiple respective third optical wavenumbers and multiple respective field distributions. The control and driver circuitry is configured to operate the acoustic signal source such that the flexural acoustic wave induced in the multicore fiber includes two acoustic waves, the first acoustic wave having a first acoustic wavenumber and the second acoustic wave having a second, different acoustic wavenumber. The first acoustic wavenumber substantially matches the difference between the first optical wavenumber and the optical wavenumber of an intermediate cladding mode selected among the multiple cladding modes (the “third optical wavenumber”), and the second acoustic wavenumber substantially matches the difference between the second optical wavenumber and the third optical wavenumber. The term “substantially matches” is herein meant to indicate that the mismatch between the first (or second) acoustic wavenumber and the difference between the first (or second) and third optical wavenumbers is smaller than the mismatch between either of the acoustic wavenumbers and the difference between the respective first or second optical wavenumber and a wavenumber associated with a non-selected cladding mode. In some embodiments, such matching is achieved with the first acoustic wavenumber being equal to the difference between the first optical wavenumber and the third optical wavenumber, and the second acoustic wavenumber being equal to the difference between the second optical wavenumber and the third optical wavenumber, respectively; in this case, the first and second acoustic waves cause resonant optical coupling between the respective (first or second) optical core mode and the selected cladding mode. In other embodiments, the first and second acoustic modes each differ from the difference between the first or second wavenumber and the third wavenumber by a specified momentum deviation percentage large enough to cause off-resonance coupling, but sufficiently small to avoid coupling to non-selected cladding mode. In either case, the field distribution of the selected intermediate cladding mode has nulls at centers of the first and second optical cores and is concentrated around boundaries of the first and second cores.

In various embodiments, the intermediate cladding mode has been selected among the multiple cladding modes to maximize a first coupling rate between the first core mode and the intermediate cladding mode and a second coupling rate between the second core mode and the intermediate cladding mode, subject to keeping the difference between the first and second coupling rates below a specified maximum rate difference (e.g., 20%, or 10%), and acoustically isolating the selected intermediate cladding mode from other cladding modes with coupling rates to the first and second core modes above a minimum rate (e.g., at least half of the coupling rates of the selected mode) by a specified minimum acoustic frequency difference (e.g., at least 4 kHz in some embodiments). The intermediate cladding mode may have been selected among a subset of the multiple cladding modes whose associated third optical wavenumbers differ from the first and second optical wavenumbers by amounts corresponding to acoustic wavenumbers within a signal generation band of the acoustic signal source.

In some various embodiments, the optical fiber is tapered, includes a stepped index profile with an inner cladding having a first refractive index and an outer cladding having a second refractive index that is lower than the first refractive index, and/or includes low-index trenches surrounding the first and second cores. In some embodiments, the switch device enables switching in under 1 us at losses of less than 0.1 dB, enables full mode conversion from the first core mode to the second core mode over an acousto-optic interaction length of no more than 40 cm (or, in some examples, no more than 30 cm), and/or achieves null coupling between the first and second cores with a crosstalk performance of −80 dB or better.

In another aspect, a method for switching light from a first core of a multicore optical fiber to a second core of the multicore optical fiber is provided. The method involves exciting a first flexural acoustic wave having a first acoustic wavenumber in the multicore optical fiber to resonantly couple the light acousto-optically from an optical mode of the first core to an intermediate cladding mode selected among multiple cladding modes, and while the first flexural acoustic wave is excited, further exciting a second flexural acoustic wave having a second acoustic wavenumber in the multicore optical fiber to resonantly couple the light acousto-optically from the intermediate cladding mode to an optical mode of the second core. Herein, the selected intermediate cladding mode is characterized by a field distribution that has nulls at centers of the first and second optical cores and is concentrated around boundaries of the first and second cores; the first acoustic wavenumber is selected to be equal to a difference between optical wavenumbers of the optical mode of the first core and the intermediate cladding mode, and the second acoustic wavenumber is selected to be equal to a difference between optical wavenumbers of the optical mode of the second core and the intermediate cladding mode. The first and second acoustic waves may be excited in the multicore optical fiber by driving an acoustic signal generator mechanically coupled to the multicore optical fiber at two frequencies computed from the first and second acoustic wavenumbers in conjunction with dimensional and acoustic parameters of the multicore optical fiber.

In yet another aspect, a method for switching light from a first core of a multicore optical fiber to a second core of the multicore optical fiber exciting a first flexural acoustic wave having a first acoustic wavenumber in the multicore optical fiber to non-resonantly couple the light acousto-optically from an optical mode of the first core to an intermediate cladding mode selected among multiple cladding modes, and while the first flexural acoustic wave is excited, exciting a second flexural acoustic wave having a second acoustic wavenumber in the multicore optical fiber to non-resonantly couple the light acousto-optically from the intermediate cladding mode to an optical mode of the second core. Herein, the first and second acoustic wavenumbers are selected such that the difference between the first and second acoustic wavenumbers is equal to a difference between optical wavenumbers of the optical mode of the first core and the optical mode of the second core, and the first and second acoustic wavenumbers each differ from a difference between the optical wavenumber of the optical mode of the first or second core, respectively, and a wavenumber of the intermediate cladding mode by a specified momentum deviation percentage large enough to cause off-resonance coupling, but sufficiently small to avoid coupling to non-selected cladding mode.

While the invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is provisionally claimed is:

1. An acousto-optic switch device comprising:
a multicore optical fiber comprising first and second optical cores surrounded by a cladding, the first optical core configured to guide a first core mode having a first optical wavenumber, the second optical core configured to guide a second core mode having a second optical wavenumber that differs from the first optical wavenumber, and the cladding configured to guide multiple cladding modes having multiple respective third optical wavenumbers and multiple respective field distributions;
an acoustic signal source configured to induce a flexural acoustic wave in the multicore optical fiber; and
control and driver circuitry configured to operate the acoustic signal source such that:
the flexural acoustic wave comprises a first acoustic wave having a first acoustic wavenumber and a second acoustic wave having a second acoustic wavenumber,
the first acoustic wavenumber substantially matches a difference between the first optical wavenumber and the third optical wavenumber of an intermediate cladding mode selected among the multiple cladding modes,
the second acoustic wavenumber substantially matches a difference between the second optical wavenumber and the third optical wavenumber of the intermediate cladding mode, and
the field distribution of the intermediate cladding mode has nulls at centers of the first and second optical cores and is concentrated around boundaries of the first and second cores.

2. The switch device of claim 1, wherein the intermediate cladding mode has been selected among a subset of the multiple cladding modes whose associated third optical wavenumbers differ from the first and second optical wavenumbers by amounts corresponding to acoustic wavenumbers within a signal generation band of the acoustic signal source.

3. The switch device of claim 1, wherein the intermediate cladding mode has been selected among the multiple cladding modes to maximize a first coupling rate between the first core mode and the intermediate cladding mode and a second coupling rate between the second core mode and the intermediate cladding mode, subject to criteria comprising:
keeping a difference between the first and second coupling rates below a specified maximum rate difference; and
acoustically isolating the selected intermediate cladding mode from other cladding modes with coupling rates to the first and second core modes above a minimum rate by a specified minimum acoustic frequency difference.

4. The switch device of claim 1, wherein the first acoustic wavenumber is equal to the difference between the first optical wavenumber and the third optical wavenumber of the intermediate cladding mode, and the second acoustic wavenumber is equal to the difference between the second optical wavenumber and the third optical wavenumber of the intermediate cladding mode.

5. The switch device of claim 1, wherein the first acoustic wavenumber differs from a difference between the first optical wavenumber and the third optical wavenumber of the intermediate cladding mode by a specified non-zero momentum deviation percentage of, and the second acoustic wavenumber differs from a difference between the second optical wavenumber and the third optical wavenumber of the intermediate cladding mode by the same specified momentum deviation percentage.

6. The switch device of claim 1, wherein the optical fiber is tapered.

7. The switch device of claim 1, wherein the optical fiber comprises an inner cladding having a first refractive index and an outer cladding having a second refractive index that is lower than the first refractive index.

8. The switch device of claim 1, enabling switching in under 1 μs at losses of less than 0.1 dB.

9. The switch device of claim 1, enabling full mode conversion from the first core mode to the second core mode over an acousto-optic interaction length of no more than 40 cm.

10. The switch device of claim 1, wherein the first and second optical cores are surrounded by low-index trenches.

11. The switch device of claim 10, enabling full mode conversion from the first core mode to the second core mode over an acousto-optic interaction length of no more than 30 cm.

12. The switch device of claim 1, achieving null coupling between the first and second cores with a crosstalk performance of −80 dB.

13. The switch device of claim 1, wherein the acoustic signal source comprises a piezoelectric transducer ring mechanically coupled to a cone-shaped glass horn.

14. The switch device of claim 1, wherein the glass horn is mounted co-axially and mechanically coupled to the multicore optical fiber in region where the multicore optical fiber is stripped of its coating.

15. The switch device of claim 1, wherein the multicore optical fiber is held between rotating fiber holders.

16. The switch device of claim 1, further comprising 1×2 fanout devices at inputs and outputs of the multicore optical fiber, each configured to couple each core of the multicore optical fiber to a separate single-core optical fiber.

17. A method for switching light from a first core of a multicore optical fiber to a second core of the multicore optical fiber, the method comprising:
exciting a first flexural acoustic wave having a first acoustic wavenumber in the multicore optical fiber to resonantly couple the light acousto-optically from an optical mode of the first core to an intermediate cladding mode selected among multiple cladding modes;
while the first flexural acoustic wave is excited, exciting a second flexural acoustic wave having a second acoustic wavenumber in the multicore optical fiber to resonantly couple the light acousto-optically from the intermediate cladding mode to an optical mode of the second core,
wherein:
the selected intermediate cladding mode is characterized by a field distribution that has nulls at centers of the first and second optical cores and is concentrated around boundaries of the first and second cores,
the first acoustic wavenumber is selected to be equal to a difference between optical wavenumbers of the optical mode of the first core and the intermediate cladding mode, and
the second acoustic wavenumber is selected to be equal to a difference between optical wavenumbers of the optical mode of the second core and the intermediate cladding mode.

18. The method of claim 17, wherein exciting the first and second acoustic waves in the multicore optical fiber comprises driving an acoustic signal generator mechanically coupled to the dual core optical fiber at two frequencies computed from the first and second acoustic wavenumbers in conjunction with dimensional and acoustic parameters of the multicore optical fiber.

19. The method of claim 18, further comprising selecting the intermediate cladding mode among the multiple cladding modes to maximize a first coupling rate between the first core mode and the intermediate cladding mode and a second coupling rate between the second core mode and the intermediate cladding mode, subject to criteria comprising:
keeping a difference between the first and second coupling rates below a specified maximum rate difference; and
acoustically isolating the selected intermediate cladding mode from other cladding modes with coupling rates to the first and second core modes above a minimum rate by a specified minimum acoustic frequency difference.

20. A method for switching light from a first core of a multicore optical fiber to a second core of the multicore optical fiber, the method comprising:
exciting a first flexural acoustic wave having a first acoustic wavenumber in the multicore optical fiber to non-resonantly couple the light acousto-optically from an optical mode of the first core to an intermediate cladding mode selected among multiple cladding modes;
while the first flexural acoustic wave is excited, exciting a second flexural acoustic wave having a second acoustic wavenumber in the multicore optical fiber to non-resonantly couple the light acousto-optically from the intermediate cladding mode to an optical mode of the second core,
wherein the first and second acoustic wavenumbers are selected such that:
the difference between the first and second acoustic wavenumbers is equal to a difference between optical wavenumbers of the optical mode of the first core and the optical mode of the second core,
the first acoustic wavenumber differs from a difference between the optical wavenumber of the optical mode of the first core and a wavenumber of the intermediate cladding mode by a specified momentum deviation percentage, and
the second acoustic wavenumber differs from a difference between the optical wavenumber of the optical mode of the second core and the wavenumber of the intermediate cladding mode by the same specified momentum deviation percentage.
